(19) United States
(12) Patent Application Publication
(10) Pub. No.: US 2002/0052674 A1
(43) Pub. Date: May 2, 2002

(54) Continuous local information delivery system and method

(76) Inventors: Ting-Mao Chang, San Jose, CA (US); Jawe Chan, San Jose, CA (US)

Correspondence Address: Ting-Mao Chang, 2126 Villanova Road, San Jose, CA, 95130, US

(21) Appl. No.: 09/935,179

(22) Filed: Aug. 21, 2001

Related U.S. Application Data
(60) Provisional application No. 60/227,454, filed on Aug. 23, 2000.

(51) Int. Cl. G05B 15/00

(52) U.S. Cl. 700/300; 700/1

(57) ABSTRACT

A system and method combine mobile information device, server computer, and a task manager to provide the mobile information device user to retrieve the information corresponding to the user's current location from a server computer over Internet. The task manager schedules search events and chooses geographic search area to retrieves user's nearby information along the travel path. The task manager is accessible to an automatic positioning system to track user's mobile position and to predict the future travel path. The task manager use the query turn-around time to plans and schedule before reach the next desired area and further uses historical search criteria to reduce the search results of current search criteria before transmitting the final results through the wireless communication bottleneck.

### CROSS REFERENCE TO OTHER APPLICATIONS

This application claims the benefit of U.S. Provisional Application No. 60/227,454, filed Aug. 23, 2000.

### BACKGROUND

1. Field of Invention

This invention relates to an efficient information searching system and method that require less communication bandwidth than the prior art. It is especially important for mobile information devices, like hand-held computers and mobile phones, which have lower communication bandwidth by nature.

2. DESCRIPTION OF PRIOR ART

Mobile information processors, such as notebook computers, handheld computers, in-vehicle computers, electronic organizers, and personal data assistants (PDA), are in themselves computer systems and are able to process information. Each kind of mobile information processor has different capabilities and features for different purposes. Because of the mobile nature, a user is not able to store a large amount of information on the mobile information processor. The user needs to connect to other systems to access other information. Because of the mobile nature, the user will typically choose wireless connection to access the information on other system. Therefore, the wireless connection capability on mobile information processors becomes important. Many mobile information processors have either an embedded wireless communication peripheral or an expansion slot for an add-on wireless communication card.

Mobile communication devices, like mobile phones or pagers, are communication devices with a small computer system embedded. The earlier mobile phone has limited capability to process information other than voice messages. The earlier pager also is only able to receive the caller's phone number. However, newer mobile phones and pagers have much more powerful processing units and larger displays to process and display extra information beyond a voice message or phone number.

A mobile information device is mobile equipment that has both information processing and communication capabilities. Both mobile information processors and mobile communication devices are mobile information device. Both have great processing and great communication capabilities, which will likely have little or no difference in the near future.

The Internet is a revolutionary technology that is a rich source of information. Through the Internet, a user can access information about the world with the click of a mouse button. The user can access information related to a company on the other side of earth from their home. Companies are promoting their product information and services or making direct sales on the Internet. The Internet is so powerful and convenient to store or retrieve information that the Internet naturally becomes the best source of information for mobile information devices.

Wireless communication bandwidth is so much lower than hardwire communication bandwidth that the wireless connection becomes a bottleneck when the mobile information device connects to the Internet. In order for the prior art to search information on Internet, they either need to know the Web site address of the information or use a search engine on the Internet to search for the information. The user needs to provide the search engine with some key words that relate to the information. However, the tremendous information on the Internet is explosively growing. The user could receive thousands of related pieces of information from a search engine. In many cases, the user only needs the local information instead of global information. Too much unnecessary information will lengthen the download of the search result. This situation will be much more serious and eventually become intolerable for the user of a mobile information device with wireless connection to Internet.

The prior art deals with the explosive global information problem by categorizing the available information. Most of the search engines on the Internet categorize the information by the information characteristics. For example, Yahoo Company categorizes their database into automobile, travel, computer, political, stock quote, etc. The user could choose the category to do the search. This approach might reduce the quantity of information returned from a search. However, it is still too many pieces of information and contains the global information within that category.

Some of the companies on the Internet further categorize their information by the geographic area, for example countries or cities. With the geographic area category, the user could search the information only in a predefined area, which usually is a government district, for example ZIP code area, city, county, state, and country, etc. One of the examples is the Sidewalk web site of Microsoft Company. The web site provides a utility to locate the stores by choosing Boolean search criteria and an area, which could be a ZIP code, a city, a county, a state, or a country. After it found the stores, it returns a map and shows the store location by making a mark on the returned map. It has the disadvantage that the searching area is predefined. The user could not choose as they wish. For example, the user could not cross a city limit or narrow down the search to a shopping mall.

Another prior art device is the Global Position System (GPS) receiver. The Global Position System receiver receives signals from one of several satellites and then determines its current position. The Global Position System receiver usually has a built-in small computer. The computer has a display that could display a simplified map and show the current position on the map. The map is either pre-stored in the computer or could be downloaded from a remote site through a wireless connection. The computer uses the current position coordinates to search a built-in database for local information, for example the closest gas stations, hospitals, or restaurants. The built-in database is stored in a memory device of the computer, for example, flash memory or CD-ROM. It has the disadvantages that information might be out-dated and the searching area may not be selectable. Some Internet map application mentions the feature to automatic download another map when user reaches the boundary of the map. The application usually downloads a fix scale of map around the user's current position. Since that, the previous map and next map usually has a lot of overlap that is a waste to the network bandwidth. To download the next map at the boundary may not be just in time because the download process takes time.

Some of the Internet web browsers provide the schedule features to automatic downloading the information through Internet. However, they are not location sensitive. The tool cannot automatically retrieve information around user's current position.

A prelitinary novelty search of classes 707/1, 701/213, 701/200 in U.S. patents, uncovered U.S. Pat. Nos. 5,751,246, 586,799, 5,839,088, 5,802,492, 5,959,577, and 6,112,520. None of which disclose the concept of a continuous local information delivery system that efficiently and continuously delivers user preferred local information through wireless telecommunication and automatically adjusts the search area and search schedule based on moving conditions and other constrains. Furthermore, none of the prior art could continuously deliver updated information just in time and fulfill the low bandwidth requirement.

### SUMMARY OF THE INVENTION

A fast and convenient local information search system and method is provided for a mobile information device user who is able to search and efficiently retrieve the information corresponding to the user's current location from Internet. The task manager of preferred embodiment of the invention smartly schedules several search events and chooses geographic search area with little or no overlap between the geographic areas of search events to retrieves user's nearby information along the travel path. The task manager of the preferred embodiment of the invention is accessible to an automatic positioning system, such as a Global Position System (GPS) or Network based positioning system, to track user's mobile position and to predict the future travel path. The task manager plans and schedule before reach the desired area and further uses historical search criteria to reduce the search results of current search criteria before transmitting the final results through the wireless communication bottleneck.

The user of the preferred embodiment of the invention has a mobile information device that is able to process information and wirelessly communicates with other computer systems on the Internet. The mobile information device of the preferred embodiment of the invention also equlps with the peripherals to accept user's command and present the search result to user.

The other computer system of the preferred embodiment of the invention is a computer server. The computer server links to a database containing information about possible search topic and corresponding geo-coded information and/or geographic information.

In the preferred embodiment of the invention, the user of the mobile information device directly connects to an Internet Service Provider ASP) wirelessly or to a mobile phone carrier and then to an ISP. After connecting to the ISP, the mobile information device can communicate with any other computer system on the Internet. The user of the preferred embodiment of the invention specifies a request and the task manager executes the request. The request describes what desired information topic is and where the information is to be located. The task manager could handle a plurality of requests at the same time. The task manager is accessible to automatic positioning system and other moving conditions or constraints to predict the future travel path, plans the geographic area and trigger condition of a search, and schedules the search according to the trigger condition, such as time or location. Several searches could be scheduled for a user's request. Then, the task manager queries a computer server on the Internet to search for information by providing triggered search criteria when trigger condition is satisfied. The computer server searches the database according to the search criteria.

The geographic area of the search criteria of the preferred embodiment of the invention describes criteria for the information topic and the geographic area where the information located. The geographic area is described in coordinates of referencing system, such as coordinates in GPS system, or a location identifier, such as cell identifier of cellular phone system. If the previous search result is stored in the mobile information device, the geographic area of the search criteria could excluded the area covered by historical search criteria when task manager plans the geographic area. In another preferred embodiment of the invention, the computer server records the user's search criteria history. The computer server searches the database according to the current search criteria and filters out the search results that match with the historical search criteria and, therefore, have already been transmitted back to the mobile device. This approach could further reduce the quantity of query information transmitted to the computer server by increasing the working load of the computer server and managing a user profile for their prior queries. The criteria for information topic are included in each query to server computer. However, criteria for information topic are the same for all the searches of a user request. In another embodiment of the invention, the criteria for information topic are replaced with an identifier for identifying the unique combination of a user and a request.

The preferred embodiment of the invention further proposed a prediction method to estimate the next information search turn-around time. With the prediction the invention could determine when to do the next search to serve the user just in time and leaves a buffer time to allow one or more other real time applications to share the communication channel. With this technique, the user could continuously do information searches, but not prevent the communication channel from executing other time critical tasks.

Another prediction method of the preferred embodiment of the invention is to utilize dynamic information, such as speed and direction of the user, to determine a best geographic area for the next search and thereby create a better query that would reduce the redundant search results from previous queries.

The search results of the preferred embodiment of the present invention could be transmitted back to the user in ascending order based on the distance from the position of each search result to user's position. In this case, the user could receive or present the closer and approaching information first and then information on farther candidates. The mobile information device memorizes the search results according to user preference or storage space limitation.

Accordingly, besides the objects and advantages of the system and method for searching local information describes in our above patent, several advantages of the present invention are:

(a) Providing a mobile information device that uses an highly efficient system and method to access the local information with a lower communication bandwidth requirement,

(b) Providing a mobile information device that is convenient and fast and uses a local information searching system and method which could find information in a user specified searching area, and match user specified criteria,

(c) Providing a mobile information device to accurately search local information by utilizing the Automatic Position System,

(d) Providing a flexible local information searching system and method with highly adjustable searching area, for example, crossing city boundaries, along the road, or a narrowed down to a shopping mall,

(e) Providing a mobile information device using the most up-to-date information on the Internet instead of local storage,

(f) Providing a mobile information device to retrieve information just in time to share a low bandwidth communication channel with other applications,

(g) Providing a mobile information device using an automatic continuous local information search capability without requiring additional user input, which is very important when a user is driving a vehicle, and

(h) Providing a mobile information device using a well-managed scheduling and planning method that reduces the redundant information transmission, thereby reducing the cost of airtime charges for the wireless connection.

### DRAWING FIGURES

A system and method for mobile devices to access local information is described. In the following description, for purpose of explanation, numerous of specific details are set forth in order to provide a thorough understanding of the present invention.

FIG.1 shows several mobile end user computers communicating with a server computer in a variety of ways.

FIG.2 shows a server computer system with links to several databases.

FIG.3 shows a user's driving route and two continuous search areas on a map.

FIG.4 shows a gap between two continuous search areas that allows missing in the uncovered area.

FIG.5 shows two predefined search area systems and differences between the systems.

FIG.6 shows a predefined search area system and a car driving north and turning right.

FIG.7 shows a predefined search area system and a car driving south and turning right.

FIG.8 shows the search scheduler determining the next search time.

FIG.9 shows an aggressive search concept that searches the information of an area before the user arrives in the area.

FIG.10 shows the estimation of the turn around time of the next search and decision of the next search area.

FIG.11 shows a car changing direction and the scheduler rescheduling the search area and excluding the overlapped area.

FIG.12 shows a graphical user interface to display the search results.

FIG. 13 shows the relation between the server computer, the client computer, and the task manager.

FIG. 14 shows the task manager and all its subsystems.

FIG. 15 shows the flow chart of user the input process in task manager.

FIG. 16 shows the flow chart of scheduling a one-time search event.

FIG. 17 shows the flow chart of scheduling a periodic search event.

FIG. 18 shows the flow chart of scheduling a continuous search event.

FIG. 19 shows the flow chart of scheduling an event in the schedule task database.

FIG. 20 shows the flow chart of executing the tin e trigger event.

FIG. 21 shows the flow chart of executing the position trigger event.

FIG. 22. shows the flow chart of reaction to change in the moving condition.

### DESCRIPTION--FIGS. 1 to 22

FIG. 1 illustrates several typical models of low bandwidth search systems, according to the present invention. User 100 is driving a car 101. An in-vehicle computer 102 on the car is linking with a remote computer 103 through linkage 104. User 100 is using the information searching service provided by the remote computer for locating merchandize. User 110 is also driving a car 111. A personal assistant device (PDA) 112 on the car 111 is linking with the remote computer 103 through linkage 112. User 110 is connected with the remote computer for retrieving the local street maps. User 120 is walking in a shopping mall and using a cellular phone 121 to link with the remote computer to inquity the merchandize on sale.

The user's computer 102, 112, 121 could be any kind of mobile computer, for example, an in-vehicle computer, a personal assistant device (PDA), an electronic organizer, a hand-held computer, or even a mobile phone. The user's computer 102, 112, 121 is capable of processing information and communicating with a remote computer 103. The preferred linkage 104, 113, 123 of the present invention between the user's computer 102, 112, 121 and the remote computer 103 could be connected through the public or private wireless and/or wired communication channel to an Internet Service Provider (ISP). The Internet Service Provider relays information to and from the user's computer 102, 112, 121 to the remote computer 103 through the Internet. On the Internet, the user's computer 102, 112, 121 could communicate with any remote computer in the world.

The user's computer 102, 112, 121 of the present invention has a Global Position System receiver. The receiver may be embedded in the mobile computer 102, 112, 121 or is an external receiver connected to the mobile computer 102, 112, 121. The software on the mobile computer 102, 112, 121 could access the GPS receiver to locate the current position dynamically.

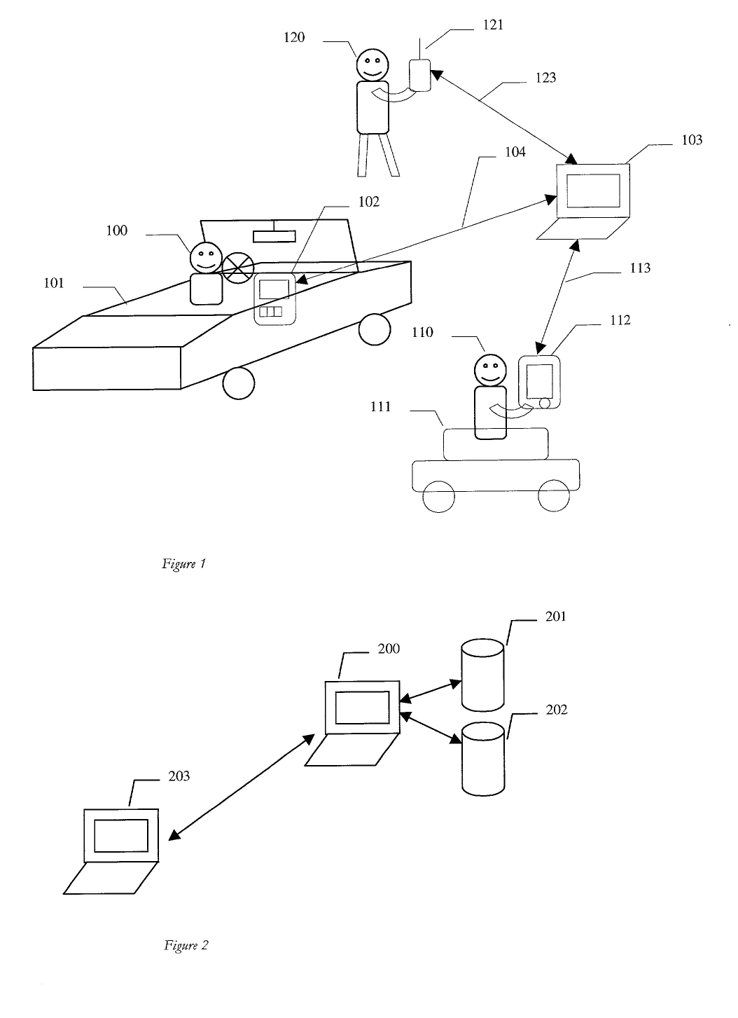

FIG. 2 illustrates a remote computer 200 that is accessible by a user's computer 203. The remote computer 200 is also accessible to one or more database systems 201, 202. One database system 201 contains the topical information and the corresponding locations. Topical information could be found in the database 201 by giving a specific search topic criteria and a geographical criteria. Another database system 202 is Geographic Information System (GIS). Using the geographic information in the database system 202, a software application on the remote computer 200 could generate a street map that is requested by a user. The remote computer 200 could access many databases, such as a traffic condition database, a restaurant information database, etc.

Searching Task Manager

Users frequently need to know information about their surroundings. In the prior art, the user uses a Palm organizer or Compact Window CE PDA with a wireless modem to access the Internet in order to do searching. It is very convenient to have a wireless connection to the Internet. However, the user has to manually repeat the search process when the user searches for the same kind of information for different locations. There is no way to efficiently use the wireless communication channel. The present invention is a solution to help resolve these problems. The preferred embodiment of the present invention has a searching task manager subsystem. The searching task manager subsystem maintains a list of searching tasks. Each searching task defines a one time searching activity or a repeating searching activity. The searching activity contains the information about what to search, where to search, and when to search. What to search includes a topic search criteria. Where to search includes a rule of geographic search area, for example a 5 miles radius circle around the user. When to search includes a search schedule, in terms of time and/or spatial location, for example any combination of a search frequency, start condition, and stop condition, and other dynamic arrangement, for example to arrange next search when approach the boundary of searched area. The present invention executes the search tasks automatically without further input or action from the user. The search result may be stored in memory or output to the user by a display or a voice synthesizer. It is especially important while the user is operating a vehicle or walking on the road.

An example of the searching task is continuously searching the traffic conditions in the surrounding area. Since this information could not be planned in advance or does not make sense to download before approaching the area and should be retrieved real time. The user is concerned about the traffic conditions on or around the current or planned travel path. So, the user could schedule two searching tasks. One searching task searches a smaller area around the current position more frequently. Another searching task searches a larger area less frequently. The search tasks could be started between 8:00 am to 9:30 am Monday to Friday when user enter highway 85.

In another example of a searching task, the user downloads the local map through the Internet, thereby alleviating the need to carry potentially out-dated information in the local computer system. However, the map itself contains a large quantity of data and the download is slow. If a map covers a large area or is in small-scale, it tends to contain an even quantity of data. The user could schedule one task for searching the detailed map and another task for searching the large-scale map. The large area and large-scale map provide a driver with large and rough geometry of their path and makes the information quantity manageable by the low bandwidth communication channel. The small scale and small area map is around the driver's current location. The small area and small-scale map provides the driver with a detailed street environment and makes the quantity of data manageable by the low bandwidth communication channel. The present invention automatically downloads two kinds of maps when user approaches the boundary of the map.

In a simple preferred embodiment of the present invention, the user initiates a searching task by providing a topic search criteria, a searching time period, and an initial geographic search area. The searching task is then stored in the searching task manager. The user's computer of the present invention periodically sends the queries to the remote computer. Each query differs by the geographic search area that relates to the user's current position as measured by an automatic positioning system. The search topic of each query is the same, but the search area is moving according to user's position. A circular search area is a good choice because checking a search target is in a circular search area is fast. The center of the circular search area is at the position of the car or user and the user may pre-select a search radius. Depending on the speed of the car and the radius, two or more continuous search circles may overlap each other.

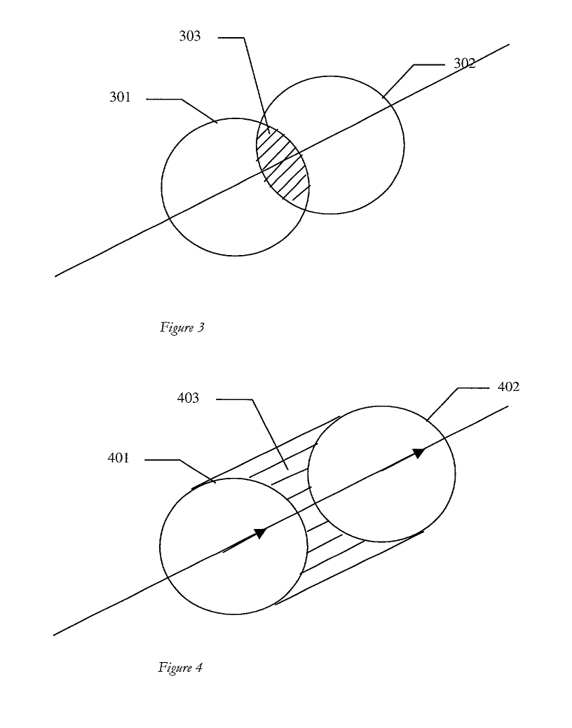

In FIG. 3, a searching task does a search within area 301 and then another search within area 302 after a period of time has passed. The user may receive updated information related to the overlapped area 303 if the information changes between two searches. The preferred embodiment of the present invention can remove the old search results on the overlapped area and update with the latest search results. If the user prefers to keep the old search result, the invention could present all the search results according to the received time of each search result. For example, present the latest received search result in front of previous received search results or include a time stamp next to each search result. If the information does not change that often, the user may receive duplicate information related to the overlapped area when each query is independently transmitted and the outputs are independently received. Since the bandwidth of the wireless connection used by the mobile device is very low, the duplicate information wastes bandwidth, if the user's computer transmits the query too often. To remove the duplicate information, the present invention has a query synthesis subsystem that synthesizes a query by excluding the previous search activities of a search task from the following search activity. To perform this task, each search activity is stored for a period of time, which could be predefined by the user. To reduce the storage cost, the invention might only store the search area of a search activity of a search task because the search topic is remaining the same. Since the previous search activities are excluded from the following search, the user could decide to store the search result for the same period of time for future reference. This technique uses the historical search activities to reduce the network traffic and speed up the searching process. The query synthesis subsystem could be implemented on the user computer or the server computer. If it is implemented on the server computer, the server computer needs to store and maintain the previous search activities on a per user basis. The generated query may be a set of query instructions that instruct the search engine to process the inquiries. For example, the following is a set of query instructions of a new query where the new coordinates are 55°50′N 12°50′E, and coordinates 55°50′N 11°50′E and 55°50+′N 10°50′E are centers of previous search areas.

1. searching topic is “piano sale”

2. searching area is “coordinates 55°50′N 12°50′E radius 10 miles”

3. exclude search area “coordinates 55°50′N 11°50′E radius 10 miles”

4. exclude search area “coordinates 55°50′N 10°50′E radius 10 miles”

Planning Where to Search

The driving speed and direction could affect the information search quality. In FIG. 4, a car is moving out of user-specified search area before the next query returns the search results. It makes the first search at 401 and the second search at 402. The driver does not have enough information in the blind area 403, which was missed by both queries. However, too much overlap in the search areas causes too much redundancy and too little search area coverage causes poor search quality. The preferred embodiment of the invention could use a predefined search area system that minimizes the overlap between searches areas, for example pre-selected discrete areas, like malls, continuous square grids, or continuous pentagonal cells. A search task then invokes a search activity when the user approaches or reaches the boundary of the already covered geographic area. Giving each search area in a predefined searching area system an identifier, all search area definitions in a query could be replaced with identifiers and an identifier for the predefined search area system. If the server already knows which predefined search area system is being using, the invention could even skip the identifier for the predefined search area system.

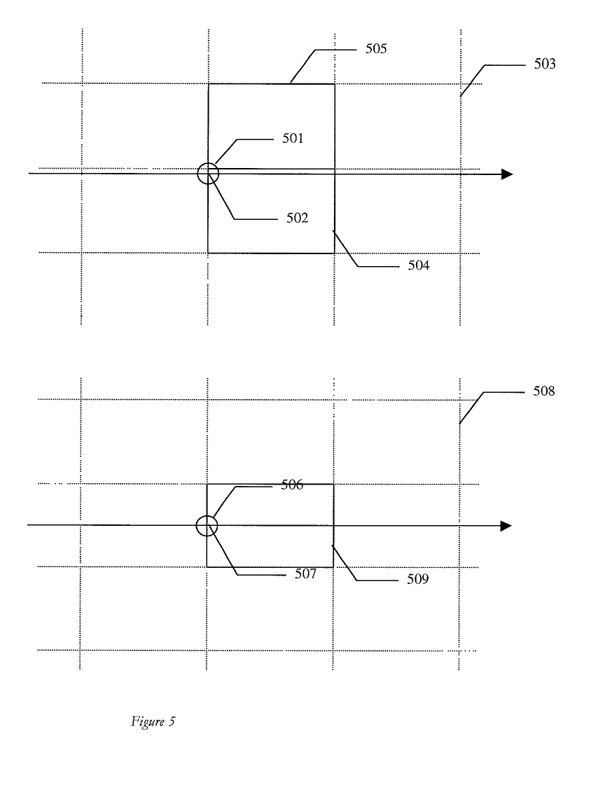

The present invention could automatically choose a different predefined search area system based on the speed and/or direction the user is moving. For example, choosing a larger grid search area while the user is moving quickly. Or, choosing a rectangular shape search area that has edges parallel to the direction of motion and covers evenly around the travel path. In order to accomplish this, the present invention has a search area planning subsystem to collect the speed and direction of motion of the user and dynamically adjust the searching area for the next query. In FIG. 5, for example, user 501 is travels through position 502. The user chose to use a predefined search area system. Predefined search area system 503 is not a good choose because the user drives around the boundary of the search area 504 where the user may loose the information on the left-hand side. To avoid that, the present invention needs an extra search area 505 for searching the information on the left. The user 506 travels through position 507. Predefined search area system 508 is a good choice because the user drives through the middle of the search area 508, so, the search area could be minimized and may find less information and use less bandwidth.

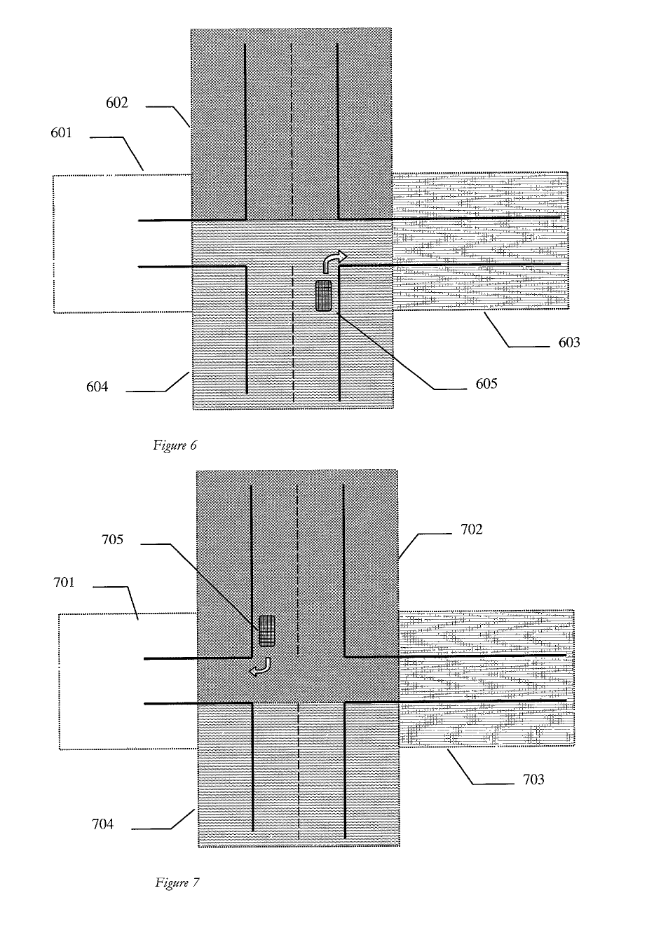

Changing the direction of motion could change the next search area. The following example uses a predefined search area system of which each search area is constructed by a road or street segment and its surrounding area. This type of predefined search area system is wells in a city area where a car moves at a slow speed. To help searching information, information vendor could associate the information somewhere on the road segment, which looks like an electronic sign to the user. The intersection in FIG. 6 and the intersection in FIG. 7 are the same one, but each figure shows a different predefined search area system. In FIG. 6, the predefined search area system shows four search areas, 601, 602, 603, and 604. A car 605 goes north with current search area 604. The next search area will be 602. However, the driver intends to turn right and switches on the right turn signal at the intersection. The present invention senses the right turn light and starts the search on search area 603. In FIG. 7, another car 705 goes south at the same intersection but selects a different predefined search area system with search areas 701, 702, 703, and 704. The current search area is 702 and the next search area is 704. The driver of car 705 intends to turn right and switches on the right turn signal. The present invention senses the right turn light and starts the search on search area 701. As we can see the difference between the two predefined search area systems are between 602 vs. 702 and 604 vs. 704. The preferred embodiment of the present invention chooses the predefined search area system that puts the intersection at the far end of a search area, so the user can foresee the condition at the intersection. The preferred embodiment of the invention senses the driving direction and chooses system in FIG. 6 or FIG. 7. For a car going north, the system will pick the system in FIG. 6. From the current position of car 605 in FIG. 6, the invention determines the current search area 604. Since the user is driving north, the next search area on north is search area 602.

Further more, the present invention could dynamically decide the best search area instead of using a predefined search area system. The original user-specified search area becomes an initial setting. The derived best search area may not be the same size or same shape as the initial setting. It may become an oval, rectangle, or square searching area. The subsystem can dynamically adjust the searching area to reduce the overlap and improve the coverage. If the user is on a planned travel route, the preferred embodiment of the invention could use the planned information to estimate the next search area. The search area planning subsystem may use one or more of the following factors to determine the best search area and best utilize the limited communication bandwidth.

the direction of motion

the vehicle turning signal

the speed of motion

a planned travel route

the query turn-around time

the current position

Planning When to Search

In FIG. 8, a user 801 is at the center 802 of a circular search area 803 with a search radius of 5 miles. The user is driving at a speed of 30 miles per hour. The user has 10 minutes left before reaching the boundary of the previous search area. The user needs to have the next search results ready before reaching the boundary of previous search area. If the average inquiry turn around time is 2 minutes, the preferred embodiment of the invention estimates the next search should start no later than 8 minutes later.

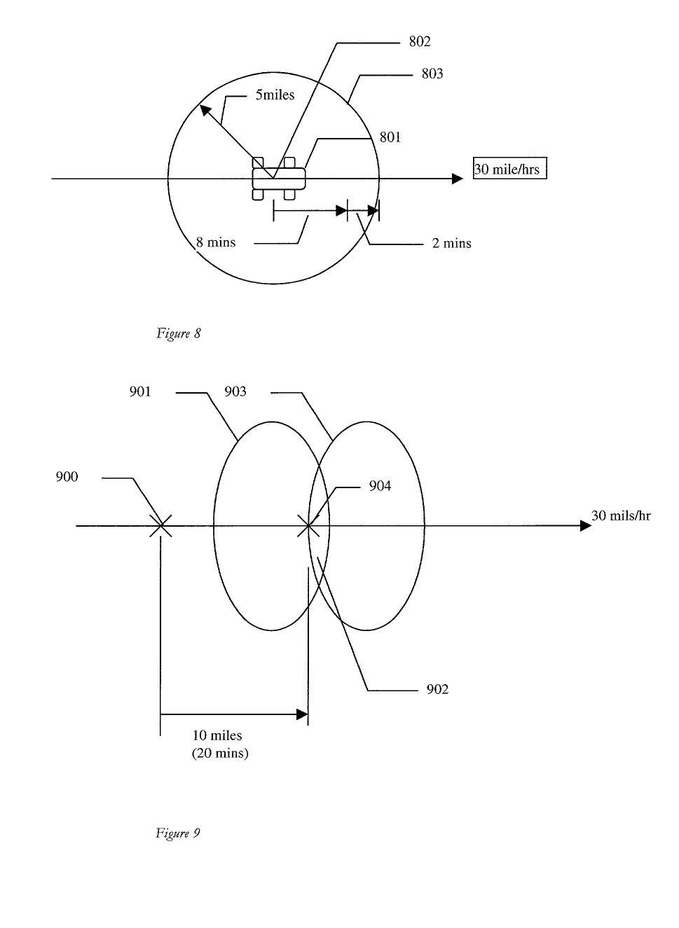

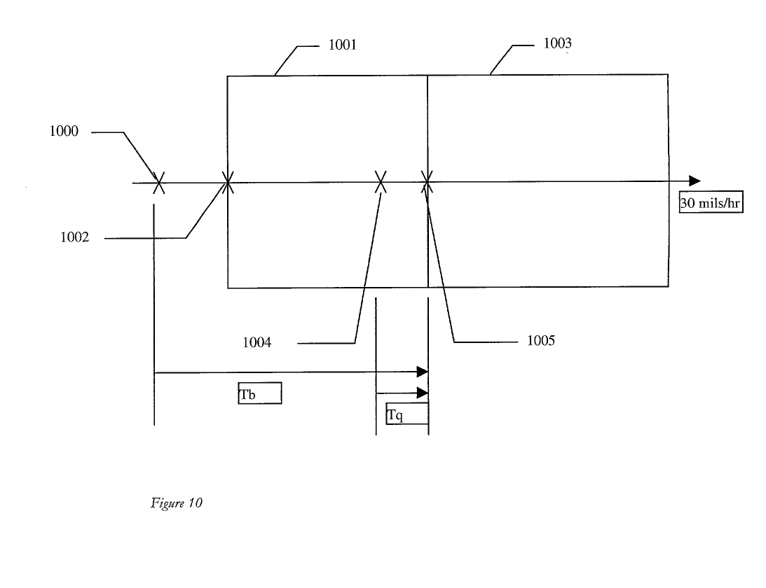

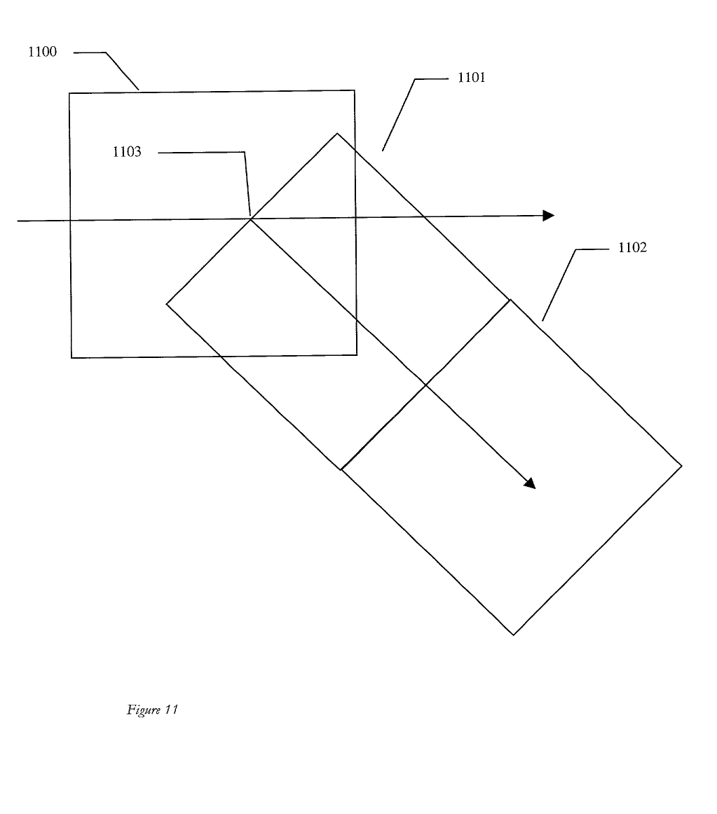

The driver of a vehicle will care more about the things he is approaching than the things he has passed. In consideration of this, the present invention uses a look-ahead search technique that always puts the search area in front of the user. In FIG. 9, the user's current position is at location 900 and the user's speed is driving at 30 miles per hour. The current search has been completed and covers the area 901. The invention decides the next search area 903 based on the previously described planning technique and calculates when or where to start the next search. Assuming the driving direction and speed remain the same and the query is done quickly, the invention calculates when the user will reach the edge of the next search area 903. For example, the user is estimated to reach the edge of the next search area 903 20 minutes later based on the user's current position and the current speed and direction the user is moving. The invention schedules the next search area at the position 904 to begin 10 minutes from the current time.

Because the search result will not return immediately, we need to take the search turn around time into consideration. FIG.10 shows an example of a travel route and several searching areas along the travel route. The different shapes of tiles, such as tile 1000 and tile 1003, are the searching areas. The driver starts a query with searching area tile 1000 on point 1000 and moves at a speed of 35 mph. If the driver finish receiving the search result at point 1002 which is at edge of tile 1001, the system will estimate the rest of the time before moving out of tile 1001 according to the current driving speed. The time before the system needs to query and receive new information for the searching area beyond tile 1000 is a buffer time Tb. Assume the driver continues to move on the current speed and direction and the estimate turn-around time for next query is Tq. Then the system allows Tb-Tq as idle time for sharing the communication channel with other applications. The system will start another query when the user reaches position 1004 such that the user still has turn-around time Tq before moving out of tile 1000. If the user prefers to have very reliable information, the user could assign a factor, which could be stored in a user profile, to enlarge the estimated turn-around time. In order to accomplish this, the preferred embodiment of the invention has a search scheduling subsystem to collect the user's velocity, current position, next search area, etc. to determine the schedule of the next search. Other than using time to schedule the next query, the present invention could also use distance or position to schedule the next query. For example, preforming the next query when the driver arrives at position 1004 or when the driver approaches the border of Tile 1003 within a distance less than 35 miles per hour times the turn-around time Tq.

A query synthesis subsystem of the present invention constructs a query based on the search area and search schedule of the next search. For example, changing the moving direction, receiving a turn signal, an acceleration signal, or a deceleration signal may trigger a new search or rescheduling. In FIG. 11, when the car arrives at point 1103, the driver makes a right turn on 1103 and the subsystem instantly generates a new searching area, tile 1101. Since tile 1101 is a bit overlapped with tile 1100, the query synthesis subsystem will generate the following query instruction as the new query.

1. Topic: five cheapest gasoline sale

2. Search Area: tile 1101 - tile 1100

3. Tile 1101: rectangle at coordinates 55°50′N 12°50′E height 2 miles and width 3 miles and direction 135°

4. Tile 1100: rectangle at coordinates 55°50′N 12°53′E height 2 miles and width 3 miles and direction 90°

5. Density: tile 1102

6. Tile 1102: rectangle at coordinates 55°45′N 12°56′E height 2 miles and width 3 miles and direction 135°

7. end

Instruction 1 indicates that the search topic is five gas stations and their gasoline price that is cheapest in the search area. Instruction 2 indicates that search area is tile 1101 minus tile 1100, where tile 1101 and tile 1100 are two of search areas. Instruction 3 defines tile 1101 as rectangular, its size, and its location. Instruction 4 defines tile 1100 as rectangular, its size, and its location. Instruction 5 requests the information density in tile 1102, which is the predicted next search area. The information density is used to predict the query turn-around time as described in the following. Instruction 6 defines tile 1102 as rectangular, its size, and its location. Instruction 7 ends the query. Using an identifier for each tile and an instruction to indicate which search area system to use, the present invention could skip the tile definition.

The information quantity, communication traffic, Internet traffic, and customer traffic on the server computer affect the query turn-around time. The preferred embodiment of the present invention has a query turn around time estimation subsystem. The subsystem incorporates many ways to collect several factors to estimate the query turn-around time. The following are the methods and factors for estimating the turn around time.

The turn around time of previous searches are stored and used as reference to predict the turn around time of the upcoming search.

The ratio of quantity of the information in the next geographic area to the quantity of information in the current geographic search area. To get this ratio, the information density, user computer makes a special request within the current query. The special request contains an extra search about the next geographic area. The server computer makes two searches. One is for the query in current search geographic area. Another searches the same topic but in the next search geographic area. The server computer returns the search result in the current search area but does not return the search result in the next geographic area.

Instead it returns the ratio of the quantity of information in next search area and the current search area.

Server site statistic on the traffic ratio of the current query to the next query. The user's computer could request the server computer report the ratio of the next traffic volume to the current traffic volume based on statistic values.

Internet routing trace information. The subsystem may trace Internet routing time to determine the time for a round trip between the user's computer and the server computer.

Search Area Constraint

Although communication bandwidth is a major concern when we determine the size of the search area, other factors could further constrain the search area to further limit the size of the returned information and reduce the bandwidth usage. For example, the gasoline remains in the gas tank determines the remaining driving distance. The user would like to find gas stations that offer the cheapest price or better service before running out of gasoline. Therefore, the present invention may contain a dynamic constraint subsystem. The dynamic constraint subsystem further constrains the geographic search area base on some dynamic information, such as remaining gasoline. The dynamic constraint subsystem may access to the sensor of the remaining gasoline and, based on the statistic energy consumption rate, determine the remaining driving distance. A more sophisticated constraint system could also monitor several other sensors as other factors, such as road condition, weather, and weight loading etc., to better estimate the remaining driving distance. If the user decides to activate this query, the user's computer automatically repeats searching activity for the gas stations that offers the cheapest gasoline or better service within the remaining driving distance.

Another example of the dynamic information is the remaining time before a meal. The constraint subsystem measures the remaining time to the next meal and adjusts the search area. It automatically reduces the search area for dining restaurants as the mealtime approaches. Another example of dynamic information is the remaining driving time before a stop for rest. The constraint subsystem monitors the length of non-stop driving duration to determine the searching distance for rest areas. It automatically reduces the search area and search distance to user for rest areas if the driver has been continuously driving for a long time.

Present Search Results

The search results are transmitted from the server computer to a remote computer through a wireless connection. The user of the present invention could choose to transmit the closer search results first and then the farther search result later, if the server side knows the user's current position and direction of motion. The server computer either receives the user's current position and/or direction of motion in a query from the searching task manager or accesses the information from another user position monitor system. The mobile device or remote computer then stores the search results in memory. Depending on processing speed of the mobile device, the present invention can present the search results in a series beginning with the information the user will arrive at first and progress through to the information the user will arrive at last.

A good presentation method is important to a mobile user. The present invention can present the search results audibly or visually. A mobile user usually is operating a vehicle or is walking while they receiving the presentation. Voice presentation is considered better because it is less distracting to a mobile user. However, visual presentation usually displays on a video screen and can present more information than vocal presentation. In either method, the presentation order of the search results is important. Closer or approaching information is usually more important to the user. The user of the present invention could choose to present a search result that is closest to the user first. The user could also choose to present a search result that the user is approaching first.

The following are some of examples about how to present search result in different scenarios. In a voice presentation, the present invention announces the closer and/or approaching search result entry first by default. After finishing the approaching search results, the user can press a button or say a voice command to instruct the mobile device to present the receding search results in an order beginning with the closest first. The user could certainly choose to present receding search results right after the approaching search result without user instruction.

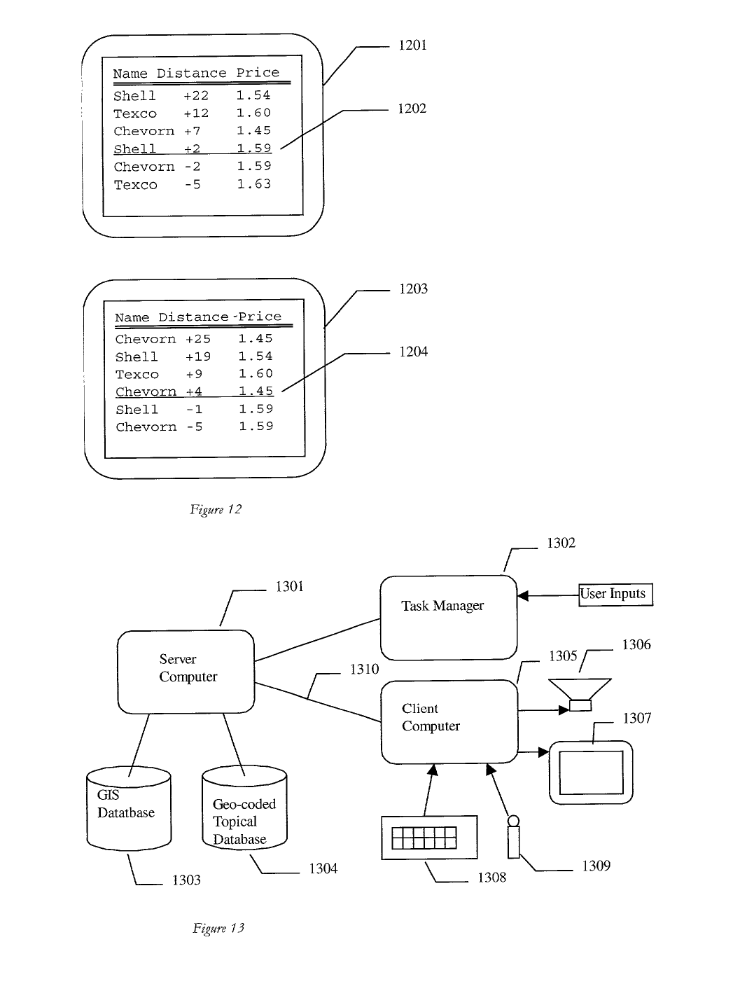

For a mobile phone handset user, the screen is small and can only display a couple lines of text The present invention compiles a list of search result that begin with far and approaching information on the top and far and leaving information on the bottom. For catching the user's eye, the present invention puts a special mark on the closest and approaching entry. A special entry could certainly be used to indicate the user's current position in the list instead of using a mark. If the list is longer than the screen can display, the present invention will only display the entries closest to the user's current position. In FIG. 12, screen 1201 displays six gas stations and their gasoline price. The four entries on the top are gas stations approaching the user with positive distances. The two entries on the bottom are gas stations leaving user with negative distances. The underlined entry 1202 is the closest approaching gas station. After 3 miles of driving, gas station 1202 is passed and the system makes another search and screen 1203 is shown. The entries are pushed down and one new entry is added on the top with greatest distance. The bottom entry on screen 1201 was pushed off on screen 1203. All the distances on screen 1203 are updated and the underlined entry changed from 1202 to entry 1204. However, it certainly could display the results in the alphabetic order or other sorting criteria related to the information itself, like price or time.

For a PDA user, the screen can display a simple map. The present invention marks the search results on the map according to their position on the map and also displays a list of search results to provide more information for the user. A mark on the map or an entry in the list could be a hyper link to other information related to that search result. The order of the list could be similar to the ordering method described in the mobile handset.

In another example, the user is looking for a price criteria of a Yamaha Piano, the user might setup a search rule about a Yamaha Piano price, coupon, and on sale information. At time 1, the user will search a geographic area with the search rule and get the first results—5 candidates. At time 2, the user will get the 2^{nd} set of the results—4 candidates. The 1^{st} and 2^{nd} results can be combined and shown to the user on his mobile phone handset. If the 1^{st} and 2^{nd} results have 2 candidates overlapped, the combined results will show only 7 candidates on the user's mobile phone handset. These 7 candidates can be sorted by name or by searching criteria (may be price) or by distance from the current user's position. The recent candidates (The 2^{nd} search results) can be highlighted, and the 1^{st} search results can show up in darker color.

The present invention couples the subsystems: search task manager subsystem, search area planning subsystem, search scheduling subsystem, query turn around time estimate subsystem, query synthesis subsystem, and dynamic constraint subsystem, such that the searching task is executed on the search area identified by the searching area planning subsystem, at the schedule decided by the scheduling subsystem, and further constrained by the constraint subsystem. The final query is further restricted by historical searching activities.

Example of System Implementations

An implementation example of the present invention is described as follows. In FIG. 13, a server computer 1301 accesses to a geo-coded topical database 1304 and geographic information system (GIS) database 1303. One client computer 1305 is shown on FIG. 13 and communicates with the server computer 1301 through a wireless telecommunication channel 1310. However, a server computer could certainly communicate with several client computers at the same time. The client computer could be a mobile computer, PDA, phone handset, etc. A task manger 1302 takes user's inputs that are for specifying a search task. The task manger parses the inputs and schedules the search tasks. A search task may schedule one or many search activities. When a search activity of a search task matures, task manager 1302 send the query of the search activity to server computer 1301. A search activity becomes mature when the user approaches or arrives at a location or when a scheduled time has elapsed or a time arrives. The server computer 1301 searches for requested topical information within the specified geographic area from the geo-coded topical database 1304. The server computer sends the search results of the query to the client computer 1302 through the wireless telecommunication channel 1310. The server computer 1301 could further generate a map for the specified geographic area from the GIS database 1303 if the client computer 1305 can display a map. The search results could be marked on the map before or after sending the map to the client computer. The client computer stores the received search results in its memory and announces the results with the speaker 1306 or displays them on a screen 1307. The screen 1307 of the client computer 1305 could also present the map received from the server computer 1301.

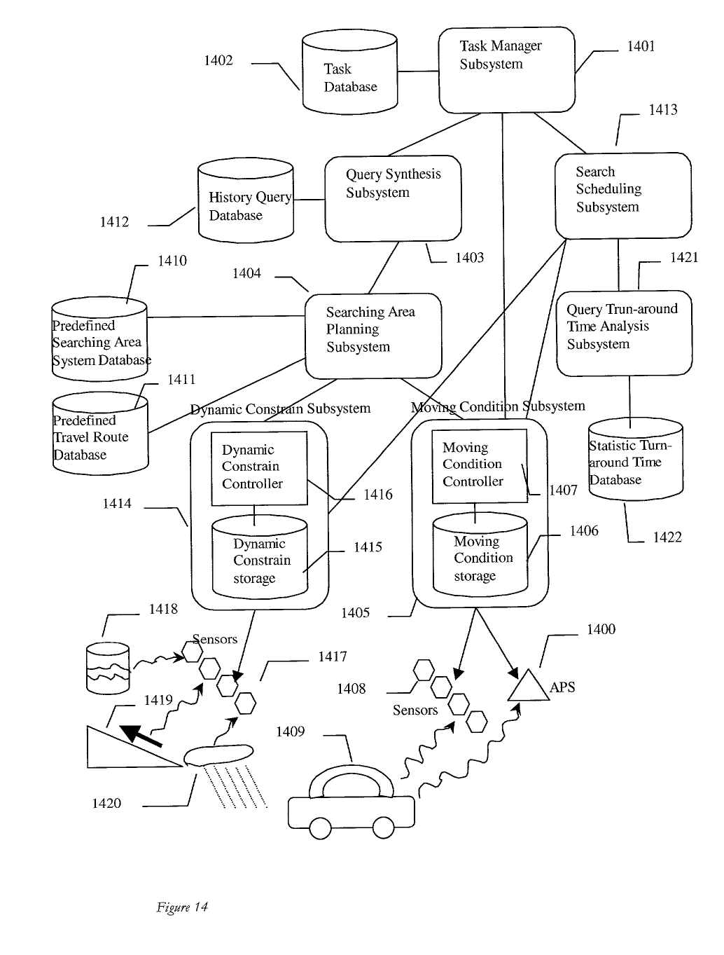

FIG. 14 is an implementation example of the task manager of the present invention. The task manager is includes task manager subsystem 1401, a search task schedule database 1402, and several other subsystems. The task manager 1401 has access to the search task schedule database 1402. When a search activity is due, the task manager sends the query of the search activity to the server computer. After a query is requested, the task manager subsystem 1401 asks the query synthesis subsystem 1403 to generate a query for the next search of the search task if it is an iterated search task. Query synthesis subsystem then request search area planning subsystem 1404 to calculate a new geographic area for the next search.

Search area planning subsystem 1404 accesses moving condition subsystem 1405, which contains a moving condition memory 1406 and a moving condition controller 1407. The moving condition controller accesses one or more sensors 1408 and stores the conditions in the memory 1406. The sensors could be for the accelerator pedal, break pedal, turn signal, and positioning systems for monitoring a moving object 1409. The positioning system could be any Automatic Positioning System (APS). Examples of automatic location instruments are GPS receivers, cellular network triangulation positioning systems, cell ID of the cellular wireless phone systems, etc.

Search area planning subsystem 1404 accesses the dynamic constraint subsystem 1414, which contains a dynamic constraint memory 1415 and a dynamic constraint controller 1416. The dynamic constraint controller has access to one or more sensors 1417 and stores constraints in the memory 1415. The sensors monitor many conditions, for example the remaining gas in the gas tank 1418, the slope of the road 1419, weather condition 1420, etc. This information provides the planning system extra information to make decisions. For example, reduce the search area if the gas remaining is low or it is time to have meal after a long drive.

If a predefined route is available, search area planning subsystem 1404 could refer to the predefined route in the predefined travel route database 1410 to predict the next search area. If the user's current position is still on the predefined route, the search area planning subsystem will estimate a geographic area to cover the closest coming travel route according to the predefined route. The user may prefer to use a predefined search area system. One of the predefined search area systems will be chosen from the predefined search area system database 1411 to provide the necessary coverage. The selection of predefined search area systems may depend on the moving conditions of the moving object 1409. For example, choose a system that has a large single search area if the object 1409 is moving quickly. Or choose a rectangular search area system that best covers the predicted travel route. The user could also predefine the size of coverage in a user profile, for example 5 miles. If the predefine search area system is not chosen, the planning system 1404 has more freedom to select a search area in any shape or angle or size that best covers the predicted travel route.

After a new search area is calculated, the search area planning subsystem 1404 returns the area to the query synthesis subsystem 1403. If the user prefers the turn-around time analysis and turns on the next query information density request, query synthesis subsystem 1403 could request search area planning subsystem to produce two continuous search areas instead of just one. Query synthesis subsystem 1403 then generate a new query. The search area may be further reduced by excluding the search area covered by a previous query, depend on user's preference. Previous queries are stored in a historical query database 1412. If the turn-around time analysis is turn on, the query of information density for the second search area will also be synthesized into the query. Query synthesis subsystem 3 then stores the new query in the historical query database 1412 and also sends it to the task manager subsystem 1401. The task manager subsystem then updates the search activity in task schedule database 1402 with the new query.

The task manager also request search scheduling subsystem 1413 to estimate when to do the next query. Search scheduling subsystem 1413 accesses moving condition subsystem 1405 and query turnaround time subsystem 1421. The query turn-around time subsystem analyzes the query turn-around time from different sources. The sources come from previous query turn-around times, the information quantity ratio, statistical network traffic information, and Internet routing trace information. The statistical network traffic information is stored in a statistical network traffic database 1422. Based on the turn-around time, moving condition of the moving object 1409 and the current search area, search scheduling subsystem 1413 estimates what time from now or where from the boundary the next query should be invoked. If what time from now is used, the task manager 1401 needs to continuously monitor the time and invoke the next query when the appropriate amount of time has elapsed. If where from the boundary is used, the task manager 1401 needs to continuously monitor the position of the moving object 1409 and invoke the next query when the distance from the moving object to the boundary of the current search area is less than an estimated length. The task manager subsystem will then reschedule the search activity in the search schedule database 1402 based on the estimate schedule from the search scheduling subsystem.

The preferred embodiment of the invention is a dynamic system that could takes feedback from subsystems. For example, the moving condition subsystem 1405 will interrupt the task manger 1401 when the moving condition of object 1409 is changed. Then, task manager subsystem 1401 will reevaluate all scheduled search tasks that related to the moving object 1409.

The task manager as described above could be implement partially on the server side and partially the client side. For example, put most of the subsystems of the task manager on the client computer that moves with a vehicle and put the statistical query turn-around time subsystem close to server computer. The subsystems on the client computer could access the turn-around time subsystem through wireless telecommunication channel. The task manager subsystem takes search task inputs from a voice command or a keyboard command from the client computer. The sensors of the moving condition subsystem and the dynamic constraint subsystem are installed on the vehicle. The preferred automatic positioning system (APS) in this case is a GPS receiver on the vehicle. However, the APS could also be a network based positioning system that could be accessed by subsystems through wireless telecommunication channel. Since sensors are close to most of the task manager subsystems, the task manager can respond to the moving condition quickly and has more control on the selection of the search area and schedule. For example, initiate a new search right away when the left turn signal is turned on. However, the cost and computing power requirement on the client computer may also be increased. In client and server point of view, the client, where most task manager subsystem located, pulls the information from server.

On another example, puts most of the subsystems of the task manager on the server side and puts the moving condition subsystem, the constraint subsystem, and their sensors on the client side with a vehicle and is able to access through wireless telecommunication channel. The invention could remove the moving condition subsystem to reduce the communication and rely on the APS to decide the moving condition. Because the search area planning subsystem and search schedule subsystem are on server side, the preferred APS in this case is a network based positioning system that could be accessed by the server side subsystems through a wired high-speed communication network. The benefit is that the task manager could simultaneously monitor several vehicles with one network base positioning system without going through wireless connections. The task manager could use an IP address, user account name, license plate number, or cellular phone number to identify the user. However, a GPS receiver on the vehicle could certainly be used to provide position information but will need to be accessed by the task manager through a wireless telecommunication channel. In this case, the client computer requires less computing power and cost less but the server computer must be powerful and complex to handle multiple vehicles or users. In client and server point of view, the server, where most task manager subsystem located, pushes the information to server.

Many of the subsystem, for example dynamic constraint subsystem and query turn-around time subsystem, described above is optional and the information provided by the subsystem could be replace with default value specified by user or system in either client or server side.

Example of Operation Flow

With reference to the remaining figures, preferred and exemplary embodiments of the invention will now be described. The embodiment is implemented with multithread programming techniques and operated on a computer system with a real time operating system. With multi-thread or multiprocessing programming, the system processes several operations concurrently. Each thread could take care of a different operation, for example, waiting for input from a user and then parsing the inputs, monitoring the moving conditions and interrupting the task manager subsystem, etc. The real-time operating system shortens the response time, therefore, the task manager could quickly react to the moving condition change. However, the non real-time operating system and single thread could certainly be used but slower.

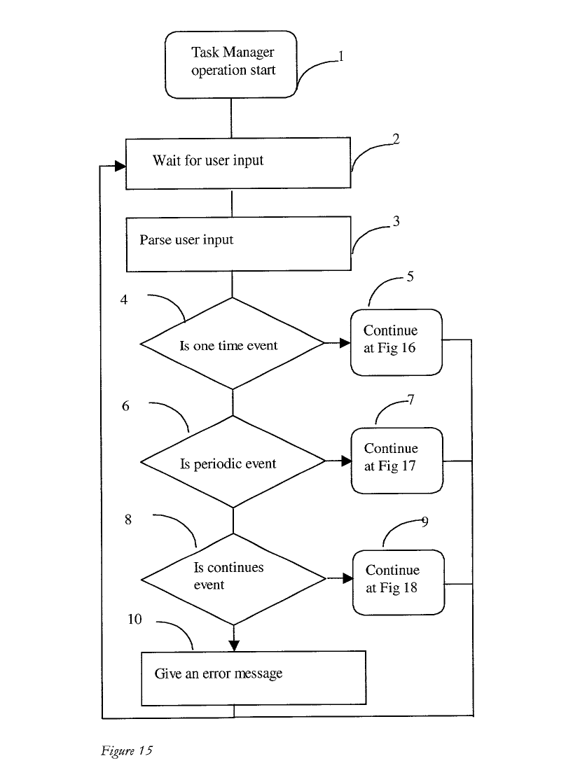

The flow chart of FIG. 15 illustrates the operation of the task manager receiving user input and scheduling a user specified search task. Step 1 waits for the new search task from the user. If the user input arrives, go to step 2 and parse the user input. If it is an one time task, go to step 5 to schedule a one-time search event which is continued in FIG. 16. If it is a periodic task, go to step 7 to schedule a periodic search event, which is continued in FIG. 17. If it is a continuous task, go to step 9 to schedule a continuous search event, which is continued in FIG. 18. Otherwise, go to step 10 to report an error. After scheduling an event or reporting an error, go back to step 2 to wait for other user input.

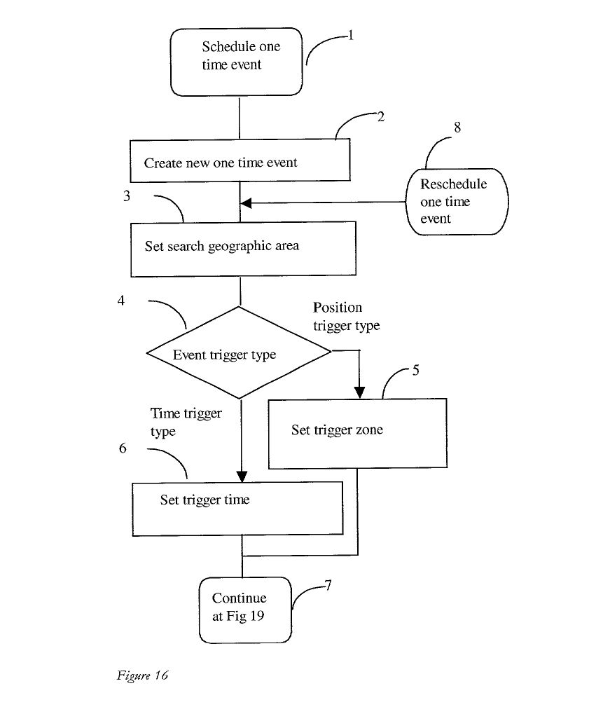

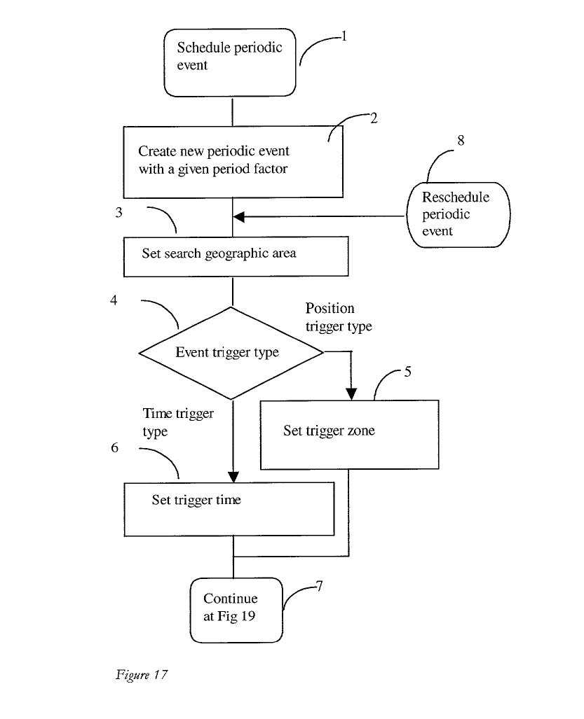

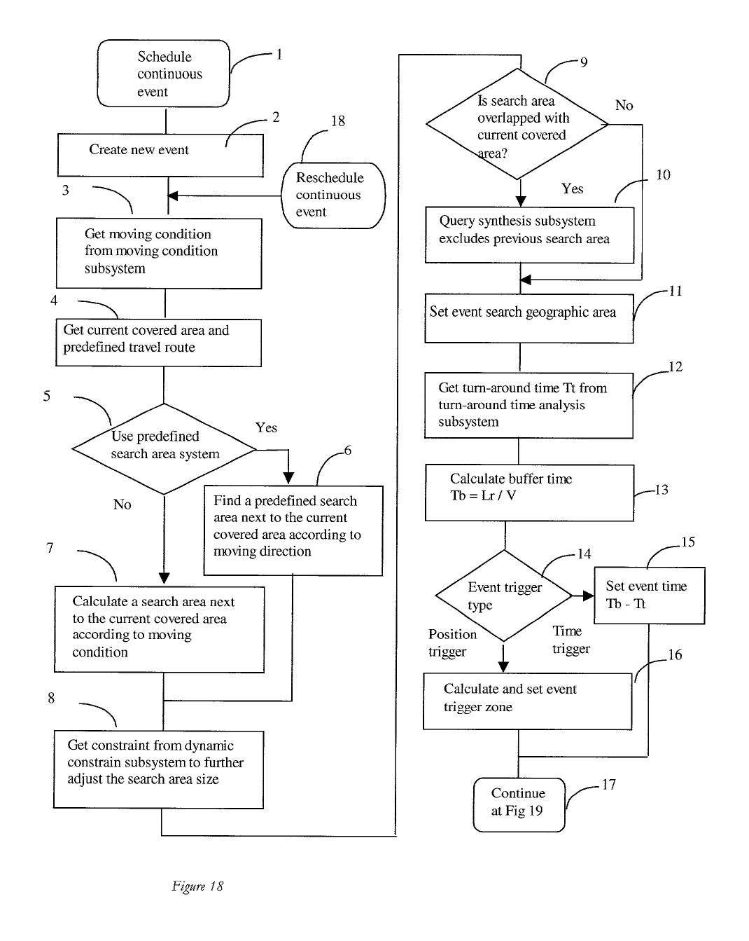

The flow chart of FIG. 16 illustrates the operation of scheduling a one-time event. Step 1 starts scheduling a new one-time event. Step 2 creates a new one-time search event. Then, step 3 sets the geographic search area. For example, the geographic search area is a 1 mile radius circle centered at the user's position when the event is triggered. Step 4 checks for the event trigger type. If it is a position triggered search event, step 5 calculate and sets the trigger zone of the event. For example, the trigger zone is an area that is 1 mile distant to the current position. If it is a time triggered event, step 6 set the trigger time of the event. For example, the trigger time is at 10:30, which is 10 minutes from now. After setting the trigger condition, continue to step 1 of FIG. 19 to schedule the event in the schedule database.

The flow chart of FIG. 17 illustrates the operation of scheduling a periodic event. Step 1 starts scheduling a new periodic event. Step 2 creates a new periodic search event by a given period factor. For example, the period could be every 20 minutes or every 10 miles. Then, step 3 sets the geographic search area. For example, the geographic search area is a 1 mile radius circle centered at the user's position when the event is triggered. Step 4 checks for the event trigger type. If it is a position triggered search event, step 5 calculates and sets the trigger zone of the event. For example, the trigger zone is an area that is 10 miles distant to the current position. If it is a time triggered event, step 6 sets the trigger time of the event. For example, the trigger time is at 10:40, which is 20 minutes from now. After setting the trigger condition, continue to step 1 of FIG. 19 to schedule the event in the schedule database.

The flow chart of FIG. 18 illustrates the operation of scheduling a continuous event. Step 1 starts scheduling a new continuous event. Step 2 creates a new continuous search event. Then, step 3 obtains the current moving condition, for example the current position and velocity, from the moving condition subsystem. Step 4 gets the current geographic search area covered by the previous search events of the search task. This operation will try to find a search area that is in the user's current direction and is adjacent to the previous covered search area. For example, the user is moving west and the previous search area covered up to 10 miles in front of the user, then the potential next search area is a geographic area that begins 10 miles to the vest. Step 4 also gets a predefined travel route from the predefine travel route database if it is available. Step 5 checks the user preference, using the predefined search area system or not. If the user chose the predefined search area system, step 6 finds a predefined search area according to the current moving condition or the predefined travel route. Otherwise, step 7 calculates a search area that best covers the future travel route, which could be a predefined travel route. After getting the search area, step 8 gets the constraints from the dynamic constraint subsystem to further adjust the search area. Step 9 checks the previous search area for overlapped with the current search area. If there is an overlap, the query synthesis subsystem synthesizes a new search area by excluding the previous search areas at step 10. Step 11 sets the final search area to the event. Then, step 12 starts the process to estimate the event trigger condition. Step 12 obtains the turn-around time estimation Tt from turn-around time analysis subsystem. Step 13 calculates the buffer time Tb. The distance from user's current position to the boundary of the final search area or the boundary of current covered search area is Lr. The buffer time is Lr divided by the user's current speed V. Step 14 checks the event trigger type. If it is a time trigger type, step 15 sets the trigger time to Tb - Tt from current time. Otherwise, step 16 calculates and sets the trigger zone of the event. For example, the rigger zone is V * Tt wide surrounding belt area around the boundary final search area. After setting the trigger condition, continue to step 1 of FIG. 19 to schedule the event in the schedule database.

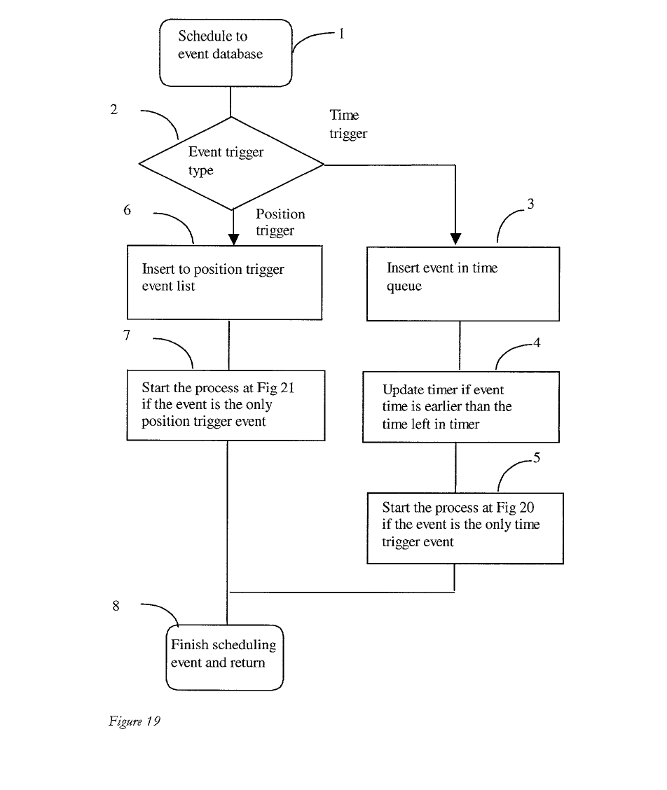

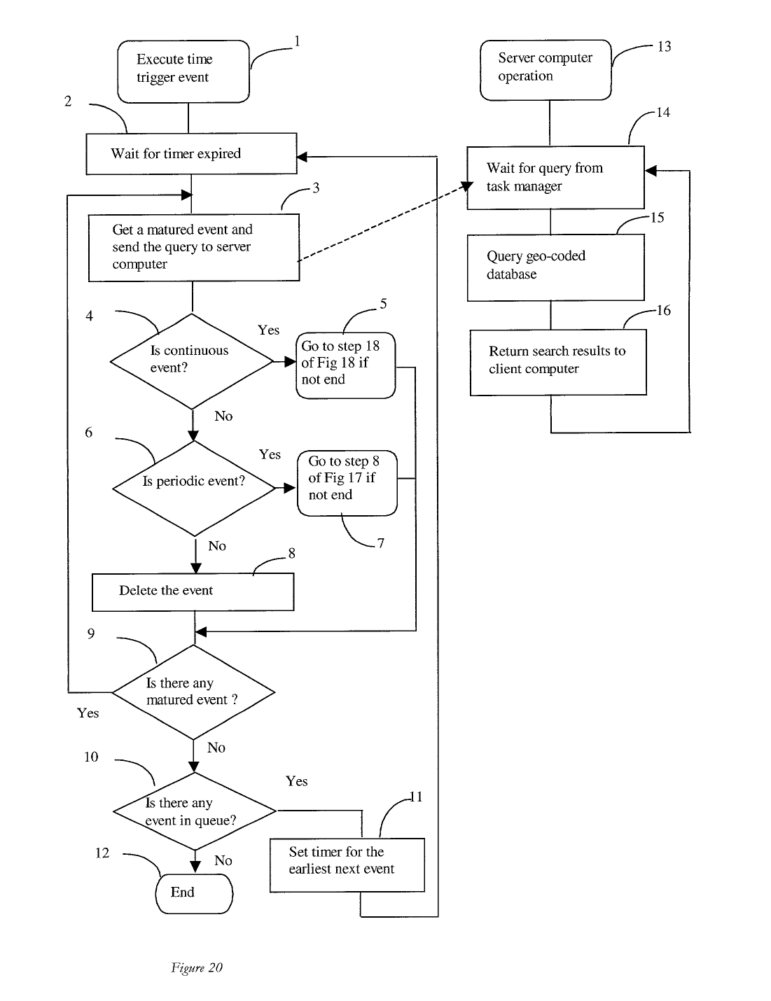

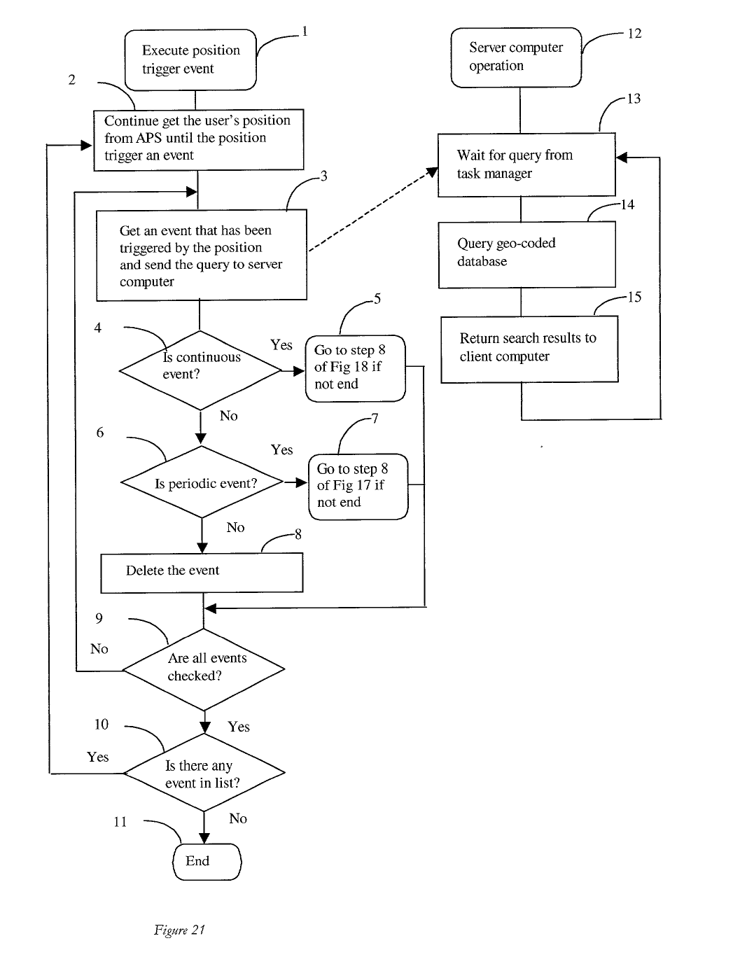

FIG. 19 illustrates the operation of scheduling the event in the event schedule database. Step 2 checks the event trigger type. If it is a time-triggered event, step 3 inserts the event in a queue according to the order of the event trigger time. A timer is designed for counting the remaining time for triggering the earliest event in the queue. Step 4 updates the timer with the trigger time of the event if the event is the earliest event in the queue. Step 5 starts the time trigger event execution process shown in FIG. 20. If the event is a position-triggered event, step 6 inserts the event into a position-triggered event list, which may be ordered by their position for a quick search. Step 7 starts the position trigger event execution process shown FIG. 21. The event schedule database is constructed to efficiently access the time-triggered events and the position-triggered events. Step 8 finishes the scheduling process and returns step 5, 7, or 9 in FIG. 15 for a new event scheduling or an event reschedule process.

FIG. 20 illustrates the operation to execute time trigger events and the interaction between the server computer and the task manager. Step 2 waits for the timer expire. When the timer expires, step 3 gets a matured event from the queue and sends the query of the event to the server computer at step 14. At the server computer, step 15 queries the geo-coded database and step 16 returns the search results to the client computer through the wireless telecommunication channel. At the same time, the task manager continues to process the event. Step 4 checks if the event is a continuous event. If it is, step 5 goes to step 18 of FIG. 18 to reschedule the event if the stop condition of the event is not meet. Step 6 checks if the event is a periodic event if the stop condition of the event is not meet. If it is, step 7 goes to step 8 of FIG. 17 to reschedule the event. Otherwise, it is a one-time event and the system deletes the event. After deleting or rescheduling the event, step 9 checks for more matured events. If there is a more matured event, go to step 3 to process more events. when done with all matured events, step 10 checks for any more events left in the queue. If there are no timetriggered events, step 12 ends the process. Otherwise, step 11 sets the timer to the earliest trigger time of the events in the queue and goes back to step 2 to wait for the timer expired.

FIG. 21 illustrates the operation to execute position trigger events and the interaction between the server computer and the task manager. Step 2 obtains the user's current position from the automatic positioning system (APS) until the position triggers an event. A position triggers an event if the position falls in the trigger zone of the event. Step 3 gets a triggered event from the list and sends the query of the event to the server computer at step 13. In step 14, the server computer queries the geo-coded database and step 15 returns the search results to the client computer through the wireless telecommunication channel. At the same time, the task manager continues to process the event. Step 4 checks if the event is a continuous event. If it is, step 5 goes to step 1I of FIG. 18 to reschedule the event if the stop condition of the event is not meet. Step 6 checks if the event is a periodic event. If it is, step 7 goes to step 8 of FIG. 17 to reschedule the event if the stop condition of the event is not meet. Otherwise, it is one-time event and the system deletes the event. After deleting or rescheduling the event, step 9 checks for more triggered events. If there is another triggered event, go to step 3 to process more events. When done with all matured event, step 10 checks for any more events left in the queue. If there is no position-triggered event, step 11 ends the process. Otherwise, the system goes back to step 2 to continue the process.

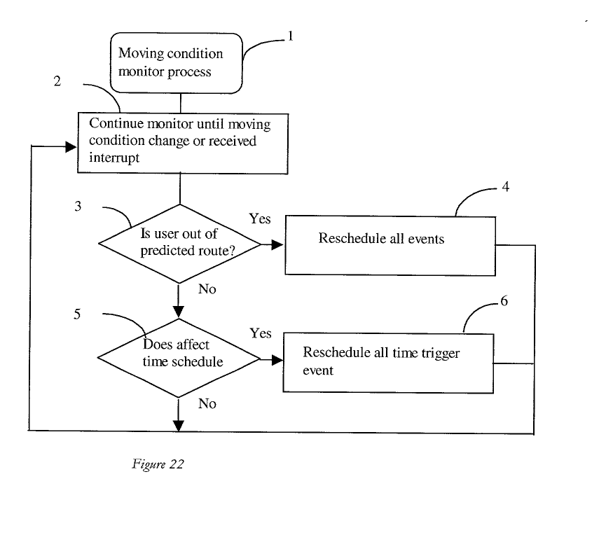

FIG. 22 illustrates the operation to react to the moving condition changing. Step 2 continues to monitor the moving condition and/or receives an interrupt from the moving condition subsystem. For example, the interrupt from the moving condition subsystem is caused by a turn signal or a break signal. If the moving condition change causes the user to potentially or actually move out of the predicted travel route at step 3, step 4 reschedules all the scheduled events, both position-triggered events and time-triggered events. If the moving condition change causes the schedule time change only at step 5, step 6 reschedules all the time-triggered events. Then, the system goes back to step 2 to continue the process.

Conclusion, Ramifications, and Scope

The present invention automatically schedules searching tasks in response to user's request and smartly uses the limited wireless communication bandwidth. The user of the invention could access nearby information, such as an ATM, a store, a lottery ticket station, a movie theater, a specific movie, on sale items, coupons, a person, jobs, etc. The retrieved information may be combination of location, time, price, person, etc.

Although the description above contains many specific details, these should not be construed as limiting the scope of the invention but as merely providing illustrations of some the possible embodiments of the invention.

Thus, the scope of the invention should be determined by the appended claims and their legal equivalents, rather than by the examples given.

We claim:

1. A method for task manager to interact with a user and provide the user nearby information of a moving object, the method comprising:
providing information and one or more geographic location related to the information in a database used by a computer
receiving a request from the user which specifies search criteria for identifying information desired by the user, including one or more geographic areas where the geographic location of the desired information is to be located and a schedule for searching desired information within the one or more geographic areas;
scheduling a query for the searching the desired information in a subset of the one or more geographic areas, including storing the query in a computer-readable storage;
processing the query according to the schedule, including querying the computer to search the database for information satisfying the search criteria; and
sending a result of the processing to the user, wherein the result identifies the information satisfying the search criteria.

2. The method of claim 1, wherein the sending are performed over a wireless communication network.

3. The method of claim 1, further comprising:
wherein the scheduling is performed in response to receiving the request from the user; and
wherein the query are in response to the request from the user; and
wherein the processing and the sending are performed in response to receiving the request from the user.

4. The method of claim 1, wherein the database is geo-coded information database.

5. The method of claim 1, wherein scheduling are performed a plurality of times to search desired information on multiple subsets of one or more geographic areas.

6. The method of claim 5, wherein the scheduling further comprise reducing the subset by removing the overlap with the subset of other query that is scheduled to performed before the query to be scheduled

7. The method of claim 1, wherein the subset is a projection of a geographic position of the moving object.

8. The method of claim 7, wherein the projection is a function of one or more factors selected from the following group:
a moving condition of the moving object;
a predefined travel route of the moving object;
a dynamic constraint;
a user preference;
a search schedule requested by user;
a search area criteria requested by user; and
a predefined search area system.

9. The method of claim 8, wherein the moving condition is selected from the following group: a direction of motion, a speed of motion, an intention of direction change, and an intention of speed change.

10. The method of claim 8, wherein the dynamic constraint is selected from the following group: an indication of remaining energy, a rate of energy consumption, and a resistance of movement.

11. The method of claim 10, wherein the resistance of movement is selected from the following group: a road condition, a weather condition, and a weight loading.

12. The method of claim 7, wherein the geographic position is determined by Automatic Positioning System (APS).

13. The method of claim 12, wherein the Automatic Positioning System is a Global Positioning System (GPS).

14. The method of claim 12, wherein the Automatic Positioning System is a Network Positioning System, wherein the location is determined via triangulation.

15. The method of claim 7, wherein the geographic position is an Automatic Location Identification (ALI).

16. The method of claim 7, wherein the geographic position is position coordinates of a referencing system.

17. The system as claimed in claim 1, wherein the scheduling defines a trigger condition of the query in response to the request and the processing is performed when the trigger condition is satisfied.

18. The system as claimed in claim 17, wherein the trigger condition is selected form the following group: arriving at a time, elapsing a period of time, approaching to a distance, arriving a geographic location, and entering a geographic area.

19. The system as claimed in claim 17, wherein the trigger condition is a function of one or more factors selected from the following group:
a moving condition of the moving object,
a predefined travel route of the moving object,
a dynamic constraint,
a user preference, and
a predicted query turn-around time.

20. The method of claim 19, wherein the moving condition is selected from the following group: a direction of motion, a speed of motion, an intention of direction change, and an intention of speed change.

21. The method of claim 19, wherein the dynamic constraint is selected from the following group: an indication of remaining energy, a rate of energy consumption, and a resistance of movement.

22. The method of claim 19, wherein the resistance of movement is selected from the following group: a road condition, a weather condition, and a weight loading.

23. The method of claim 19, wherein the query turn-around time is determined by one or more of the following group: a turn-around time of previous query, a predicted data quantity ratio between the to be scheduled query and the previous query, a statistic turn-around time of previous queries, and a query turn-around time calculated from the internet routing trace information.

24. The method of claim 18, wherein the processing is to be performed a period of time before reaching the boundary of the area selected from the following group: the subset of the one or more geographic areas of the query to be scheduled and the subset of the one or more geographic areas of the query has been scheduled.

25. The method of claim 24, wherein the period of time is determined by a predicted query turn-around time.

26. The method of claim 18, wherein the processing is to be performed at a distance before reaching
the boundary of the area selected from the following group:
the subset of the one or more geographic areas of the query to be scheduled and
the subset of the one or more geographic areas of the query has been scheduled.

27. The method of claim 26, wherein the distance is defined by a speed of the moving object times a predicted query turn-around time.

28. The method as claimed in claim 1, wherein sending the information of the result in an order that is determined by the distance between the geographic location of the information to the moving object.

29. The method as claimed in claim 1, wherein sending the information of the result in an order that is determined by whether the moving object is approaching or leaving the geographic location of the information of the result.

30. The method as claimed in claim 1, wherein the sending sends the result to a second computer and the second computer presents the result audibly or visually to the user.

31. The method as claimed in claim 30, wherein the second computer presents the information of the result in an order related to the distance between the position of said moving object and the geographic location of the information of the result.

32. The method as claimed in claim 30, wherein the second computer presents the information of the result in an order related to whether said moving object is approaching or leaving the geographic location of the information of the result.

33. The method as claimed in claim 1, further comprising rescheduling the query when the moving condition of the moving object changed.

34. A method for continuously searching local information comprise steps of
receiving one or more inputs from user;
parsing said one or more inputs and constructing search task, wherein said search task describing a criteria of search topic and a geographic search area related to a search schedule and a moving object;
scheduling one or more search activities according to said search task in a search task database;
executing said one or more search activities by querying server computer according to said search schedule;
searching a geo-coded topical database for queried said one or more search activities; and
transmitting search results of said searching step to client computer over wireless telecommunication channel, and rescheduling or terminating said one of said one or more search activities after being executed, wherein said rescheduling do said scheduling step at different time, place, and environment.

35. The method of claim 34, wherein said scheduling step further comprising: planning the geographic search area of said search activity; and determining trigger condition of said search activity.

36. The method of claim 35, wherein said planning step further comprising one or more of the following sub-steps to decide said geographic search area of said one or more search activities:
getting moving condition of said moving object from moving condition subsystem;
retrieving predefined travel route that help predict the moving path and estimating the geographic search area of said next query, and
getting dynamic constraint from dynamic constraint subsystem to further limit the search area.

37. The method of claim 36, wherein said moving condition is selected from the following group: a current position, a direction of motion, a speed of motion, an intention of direction change, and an intention of speed change.

38. The method of claim 37, wherein the current position is determined by an Automatic Positioning System (APS).

39. The method of claim 38, wherein said automatic positioning system is a Global Positioning System (GPS).

40. The method of claim 38, wherein said automatic positioning system is a network based positioning system, wherein the location is determined via triangulation.

41. The method of claim 36, wherein said dynamic constraint is selected from the following group: an indication of remaining energy, a rate of energy consumption, and a resistance of movement.

42. The method of claim 41, wherein said the resistance is selected from the following group: a road condition, a weather condition, and a weight loading.

43. The method of claim 36, further comprising step of choosing said geographic search area from predefined search area system database.

44. The method of claim 36, further comprising step of reducing the geographic search area of previous search activity of said search task.

45. The method of claim 35, wherein said determining step further comprises one or more of the following sub-steps:
getting moving condition of said moving object from moving condition subsystem, getting dynamic constraint from dynamic constraint subsystem for shorten the scheduled time or scheduled distance, and
retrieving predicted query turn-around time.

46. The method of claim 45, wherein said moving condition is selected from the following group: a current position, a direction of motion, a speed of motion, an indication of speed change, and an indication of direction change.

47. The method of claim 46, wherein the current position is determined by an automatic positioning system (APS).

48. The method of claim 47 wherein said automatic positioning system is a Global Positioning System (GPS).

49. The method of claim 47, wherein said automatic positioning system is a network based positioning system, wherein the location is determined via triangulation.

50. The method of claim 45, wherein said dynamic constraint is selected from the following group: an indication of remaining energy, a rate of energy consumption, and a resistance of movement.

51. The method of claim 50, wherein said resistance is selection from the following group: a road condition, a weather condition, and a weight loading.

52. The method of claim 34, wherein the transmit order of said one or more search results are determined by one or more of the following factors:
the relative distance between the position of said moving object and each of said one or more search results, and
the relative direction between said moving object and each of said one or more search results.

53. The method of claim 34, wherein said remote computer presents said one or more search results in voice or in visual.

54. The method of claim 34, wherein said remote computer presents said one or more search results in an order depended on one or more of the following factors:
the relative distance between the position of said moving object and each of said one or more search results, and
the relative direction between said moving object and each of said one or more search results

53. A computer system comprising one or more computers connected to a computer network, and computer instructions executed by the computer system for performing the acts in claim 1.

54. A computer-readable storage medium encoded with computer instructions for performing the acts in claim 1.

55. A continuous local information searching system, comprising:
a server computer having a server transmitter,
an informational database containing topical data and geographic data, said informational database accessed by said server computer,
a searching task manager configured to receive a search request from user, schedule one or more search queries according to said search request, and query said server computer with said one or more search queries, said search request describing a search topic and one or more geographic areas within which said desired search topic is to be located, said one or more geographic areas relate to a moving object and said schedule, and
a mobile computer having a mobile receiver configured to receive the result of said query from said server transmitter.

56. The system as claimed in claim 55, wherein said search query is response to said search request, including a criteria for said search topic and a subset of said one or more geographic areas where said search topic is to be located.

57. The system as claimed in claim 56, wherein said searching task manager further comprises a searching area planning subsystem to plan for said subset of one or more geographic areas of said query.

58. The system as claimed in claim 57, wherein said searching area planning subsystem determines said one or more geographic areas based on information provided from one or more supporting subsystems.

59. The system as claimed in claim 58, wherein said supporting subsystem is a query turn-around time prediction subsystem.

60. The system as claimed in claim 58, wherein said supporting subsystem is a planned travel route subsystem that provides one or more planned travel routes and determines the planned travel route where the moving object is on.

61. The system as claimed in claim 58, wherein said supporting subsystem is a moving condition subsystem that provides the movement of the moving object.

62. The system as claimed in claim 61, wherein said movement of the moving object is selected from the following group: a current position, a direction of motion, a speed of motion, and a moving signal.

63. The system as claimed in claim 62, wherein said moving signal is selected from the following group: a direction change signal, an acceleration signal, and a deceleration signal.

64. The system as claimed in claim 63, wherein said supporting subsystem is a dynamic constraint subsystem that provides dynamic constraint information.

65. The system as claimed in claim 64, wherein said dynamic constraint information is selected from the following group: an indication of remaining energy, a rate of energy consumption, and a resistance of movement.

66. The system as claimed in claim 65, wherein said resistance is selected from the following group: a road condition, a weather condition, and a weight loading.

67. The system as claimed in claim 62, wherein said current position determined by an automatic positioning system (APS).

68. The system as claimed in claim 67, wherein said automatic positioning system is a Global Positioning System.

69. The system as claimed in claim 67, wherein said automatic positioning system is a network based positioning system, wherein the location is determined via triangulation.

70. The system as claimed in claim 56, further comprising a query synthesis subsystem for synthesizing one or more instructions of said one or more queries.

71. The system as claimed in claim 70, wherein said query synthesis subsystem further reduce said subset of one or more geographic areas of the query to be scheduled by removing the overlapping with the subset of one or more geographic areas of scheduled query.

72. The system as claimed in claim 55, wherein said searching task manager further comprises a search scheduling subsystem that provides a trigger condition for said one or more queries.

73. The system as claimed in claim 72, wherein said trigger condition is selected form one or more of the following group: arriving at a time, elapsing a period of time, approaching to a distance, arriving a geographic location, and entering a geographic area.

74. The system as claimed in claim 73, wherein said trigger condition is a function of one or more factors selected from the following:.
a moving condition of the moving object,
a predefined travel route of die moving object,
a dynamic constraint,
a user preference, and
a predicted query turn-around time.

75. The system as claimed in claim 55, wherein the transmit order of said one or more search results is determined by the distance between the position of said moving object to one of said one or more search result.

76. The system as claimed in claim 55, wherein the transmit order of said one or more search results is determined by whether said moving object is approaching or leaving one of said one or more search results.

77. The system as claimed in claim 55, wherein said remote computer presents said one or more search results audibly or visually.

78. The system as claimed in claim 77, wherein said remote computer presents said one or more search results in an order related to the distance between the position of said moving object and one of said one or more search result.

79. The system as claimed in claim 77, wherein said remote computer presents said one or more search results in an order related to whether said moving object is approaching or leaving one of said one or more search results.
